(19) United States
(12) Patent Application Publication
(10) Pub. No.: US 2010/0072053 A1
(43) Pub. Date: Mar. 25, 2010

(54) METHOD FOR PROCESSING AND ALSO RECYCLING SLUDGE

(75) Inventor: Gunter Hans Kiss, Lesa (IT)

Correspondence Address: SCHWEGMAN, LUNDBERG & WOESSNER, P.A., P.O. BOX 2938, MINNEAPOLIS, MN, 55402, US

(73) Assignee: Litesso-Anstalt, Triesenberg (LI)

(21) Appl. No.: 12/547,269

(22) Filed: Aug. 25, 2009

(30) Foreign Application Priority Data
Aug. 26, 2008 (EP) 08015059.2

(51) Int. Cl. B09B 3/00; C10B 53/00

(52) U.S. Cl. 201/28

(57) ABSTRACT

The method according to an example of the invention relates to a method for processing and also recycling sludge which has precipitated from waste in a sediment tank within the scope of the high temperature treatment. This is dried and mixed with preportioned solid plastic materials so that solid conglomerates are formed and returned then to the high temperature treatment of the waste.

### CLAIM OF PRIORITY

The present patent application claims the priority benefit of the filing date of European Patent Application No. 08 015 059.2, filed Aug. 26, 2008, the entire content of which is incorporated herein by reference in its entirety.

The method according to an example of the invention relates to a method for processing and also for recycling sludge which has accumulated in a settling tank within the scope of the high temperature treatment of waste. For this purpose, the sludge is dried and mixed with preportioned solid plastic materials so that solid conglomerates are formed and then are returned to the high temperature treatment of the waste.

A high temperature treatment of waste is explained in more detail in the patent specifications DE 41 30 416 C1 and UA 41 263 C2. Here a method for disposing of and using waste of all types is described, in which unsorted, untreated waste containing pollutants of whatever type in solid and also liquid form are subjected to a temperature treatment.

The waste is firstly compacted whilst maintaining the mixture and composite structure thereof. The resulting compacted bales are pressed into an externally heatable oblong channel, a gas-tight plug being formed in front of the channel entrance which adopts a seal function because of the gas impermeability thereof.

Whilst the gas pressure is building up, the compacted bales are retained in frictional contact with the hot channel walls only until the entrained liquids and readily volatile materials are evaporated, until any restoring forces present of individual components are eliminated and until the entrained organic components have adopted at least partially a binding agent function. The result is hence dust-free, form-stable and structurally-stable, crumbly conglomerates subsequently fall into the shaft of a high temperature reactor and form a gas-permeable, dust-free bed.

The organic components of the waste are gasified in the reactor by the addition of oxygen. Because of the hereby resulting gasifying temperature of up to 2000° C., the inorganic components, such as glasses, metals and other minerals, are melted in the melting zone of the high temperature reactor below the bed.

The withdrawn melt can however be characterised, in the case of waste material supplied unsorted, by an extensively non-homogeneous structure. Higher-melting components, for example carbon, carbon black but also specific metals, are still present in their solid aggregate state and form inclusions which prevent useful recovery of these slag-like residual products.

The residual products present in molten form are therefore subjected to an additional subsequent treatment in that they are subjected to a thermal homogenisation process. The melt is hereby cleansed in an oxidising atmosphere until even long-term ability to be eluted is precluded.

The high temperature reactor can be characterised in that it is retained at at least 1000° C. over the entirety of its volume. The gaseous and solid waste materials remain subjected to a high temperature treatment until all the pollutants able to react thermally are safely destroyed and long-chain hydrocarbons are cracked. As a result, the formation of condensates such as tar and oil, is reliably prevented.

The gas mixture heated above 1000° C. which comprises synthesis crude gas and steam is cooled immediately after leaving the high temperature reactor in a shock-like manner to below 100° C. The liquid and solid particles entrained in the gas flow are absorbed together with the condensed steam by the cooling water.

The above-described gasification process provides that the solid particles, such as carbon, carbon black, dust, elementary metals and metal compounds which evaporate because of the high gasification temperature leave the high temperature reactor via the gas outlet and condense due to the shock-cooling and also mineral compounds are deposited in a settling tank. They are subsequently discharged, dewatered and supplied again to the gasification process as thick sludge at the transition from the degasification channel to the high temperature reactor.

The sudden contact of the sludge with the high temperature in the high temperature reactor of above 1000° C. leads to explosion-like evaporation of the water contained in the sludge. The steam entrains the solid particles originally bonded in the sludge. Organic solid particles, such as carbon, carbon black and other organic waste components, are entrained partially, together with the inorganic particles contained in the sludge and the light waste components present on the solid bed, with the steam produced in an explosion-like manner and the synthesis gas formed in the lower region of the high temperature reactor and thus pass via the shock-cooling (quenching) again into the settling tank.

Gasification of the carbon contained in the sludge and/or integration of the elementary metals and metal compounds in the inorganic melt are precluded.

The method of the state of the art hence leads to the sludge requiring to be returned again and again to the gasification process, which necessarily leads to the fact that the quantity of sludge increases and the freely available capacity for gasification of waste correspondingly drops.

In order to prevent a further reduction in capacity of this type by the sludge from the settling tank, it was also proposed to dry at least a part of this sludge and to dispose of it separately. Since this sludge essentially comprises carbon and carbon black, this fuel loss must however be compensated for.

Existing approaches can be improved, such as by providing a process such that repeated return of the sludge is dispensed with and hence also a fuel loss can be compensated for.

This can be achieved by the method having the features of claim 1. The sub-claims 2 to 11 can represent other aspects of this method.

The present method can use the sludge of the settling tank usefully as fuel in the high temperature gasification. With this method, the thermal performance of the gasification process is perceptibly improved and the available capacity can be used optimally for the gasification of waste.

According to an example of the invention, a method for processing and/or recycling sludge which has accumulated in a settling tank and comprises solid particles in a aqueous slurry is provided, the solid particles, as component of the crude synthesis gas, being absorbed by the quenching water by means of shock-cooling (quenching) of the crude synthesis gas which is produced in a high temperature treatment of waste of all types and is deposited as sludge in the settling tank. This method can be characterised in that the sludge is removed from the settling tank, dried at least partially and subsequently mixed with preportioned solid plastic materials, a mixing ratio of the dried sludge to the preportioned solid plastic materials of 0.5:1.5 to 1.5:0.5 being maintained.

This mixture can be treated under the effect of temperature and pressure until the plastic materials adopt the binding agent function and form solid conglomerates with the solid particles of the sludge. Subsequently, these solid conglomerates (briquettes) are returned to the high temperature treatment of the waste.

Preferably, a mixing ratio of the dried sludge to the preportioned solid plastic materials of 0.8:1.2 to 1.2:0.8, particularly preferred of 1:1, is thereby maintained.

The solid particles contained in the sludge are carbon, carbon black, mineral particles, condensed metals, metal compound and/or further inorganic solid particles.

It can be shown that these solid particles can be conglomerated very well with the preportioned plastic materials so that a return to the gasification process is made possible.

In an example, comminuted plastic material waste is used as solid preportioned plastic materials in the method according to an example of the invention.

These are easy to portion and hence significantly facilitate handling.

This plastic material waste can be present in the form of granulates and/or as lumpy material. Furthermore, fibres cut as preportioned solid plastic materials can be used. It is hence possible to select, as a function of the sludge components, the degree of comminution of the plastic material which is best suited to conversion of the particles. In addition, this reduces the energy consumption during conversion of the plastic material with the sediments since the formation of conglomerate can be effected more rapidly, more easily and better with as large a contact surface as possible.

The mixture of the solid plastic materials with the dried sludge is implemented, in a preferred variant of the method, in an extruder under pressure and temperature. By means of the extruder, good mixing through of the different components used is made possible such as by means of heat and pressure. Furthermore, the material can be extruded thus subsequent to the mixing process in the preferred form for further use (e.g. as fibre, balls, granulate etc.) and does not require to be transferred into the extruder from another mixing device with time consumption and material loss.

Advantageously, the process heat of the high temperature treatment can be used to dry the sludge separated from the settling tank. This measure serves to save energy. Since it is sensible to withdraw the water from the sludge before it is converted with plastic materials, the heat which is released during the high temperature treatment can be used usefully in this manner. Thus the energy produced by the combustion process and otherwise lost as waste heat is used usefully for the method.

The drying of the sludge separated from the settling tank can be effected in a container, preferably under vacuum. This serves to accelerate the drying and prevents the introduction of undesired materials, which can be contained in other gas environments, into the conglomerate.

In an example of a method variant, for the high temperature treatment of the waste, the waste is compacted without comminution whilst entraining any liquid components present and also maintaining the mixture and composite structure thereof in batches to form compacted bales and, whilst maintaining the pressure impingement, is introduced in a form fit into a channel heated to above 100° C. Portions of this method are explained above in detail (DE 41 30 416 C1 and also UA 41 263 C2). The compacted material, when sliding, is thereby retained in frictional contact with the walls of the channel and the solid conglomerate pressed out of the channel subsequently is introduced into a high temperature reactor maintained at at least 1000° C. over the entire volume thereof. In addition the crude synthesis gas is removed at the top and is supplied to the shock-cooling (quenching). At the lower side of the high temperature reactor, the molten solids are discharged and granulated.

According to an embodiment of the invention, it is now proposed to return solid conglomerates (briquettes) obtained from the sludge to a high temperature process of this type.

The solid conglomerates (briquettes), with the compacted bales which are formed from the waste, can thereby be introduced into the heated channel e.g. via a waste bunker. Thus the waste products which have been converted with plastic materials within the scope of the method according to the invention can be used for renewed gasification. The briquette thereby passes via the heatable degassing channel into the gasification region of the high temperature reactor in which the organic components of this briquette are gasified with oxygen. The inorganic components are melted and pass into the inorganic melt.

In certain examples, the invention, relative to the state of the art, can have one or more of the following advantages:
The organic components contained in the waste are gasified as completely as possible, which leads to higher energy efficiency.
The use of pretreated sludge from the settling tank does not lead to a reduction in the disposal capacity because the solid particles of this sludge are gasified or respectively melted as completely as possible.
The external partial disposal of the sludge from the settling tank is dispensed with.

what is claimed is:

1. A method for processing and/or recycling sludge which has accumulated in a settling tank and comprises solid particles in an aqueous slurry, the sludge being formed by shock-cooling (quenching) from a crude synthesis gas which is produced in a high temperature treatment of waste of all types, wherein
the sludge is removed from the settling tank, dried at least partially and subsequently mixed with preportioned solid plastic materials,
a mixing ratio of the dried sludge to the preportioned solid plastic materials of 0.5:1.5 to 1.5:0.5 being maintained, in that this mixture is treated under the effect of temperature and pressure until the plastic materials adopt the binding agent function and form solid conglomerates with the solid particles of the sludge, and in that subsequently these solid conglomerates are returned to the high temperature treatment of the waste.

2. The method according to claim 1, wherein a mixing ratio of 0.8:1.2 to 1.2:0.8, and/or 1:1,is maintained.

3. The method according to claim 1, wherein the solid particles contained in the sludge are carbon, carbon black, mineral particles, condensed metals, metal compound and/or further inorganic solid particles.

4. The method according to claim 1, wherein comminuted plastic material waste is used as solid preportioned plastic materials.

5. The method according to claim 4, wherein the plastic material waste is present in the form of granulates and/or as lumpy material.

6. The method according to claim 1, wherein fibres cut as preportioned solid plastic materials are used.

7. The method according to claim 1, wherein the mixture of the solid plastic materials with the dried sludge is implemented in an extruder under pressure and temperature.

8. The method according to claim 1, wherein the process heat of the high temperature treatment is used to dry the sludge separated from the settling tank.

9. The method according to claim 1, wherein the drying of the sludge separated from the settling tank is effected in a container, preferably under vacuum.

10. The method according to claim 1,
wherein
for the high temperature treatment of the waste, the waste is compacted without comminution whilst entraining any liquid components present and also maintaining the mixture and composite structure thereof in batches to form compacted bales and, whilst maintaining the pressure impingement, is introduced in a form fit into a channel heated to above 100° C.,
in that the compacted material, when sliding, is retained in frictional contact with the walls of the channel and the solid conglomerate pressed out of the channel subsequently is introduced into a high temperature reactor maintained at at least 1000° C. over the entire volume thereof and in that the crude synthesis gas is removed at the top and supplied to the shock-cooling (quenching) and
in that, at the lower side of the high temperature reactor, the molten solids are discharged and granulated.

11. The method according to claim 10, wherein the solid conglomerates are introduced into the heated channel with the compacted bales.
